(19) United States
(12) Patent Application Publication
(10) Pub. No.: US 2008/0199621 A1
(43) Pub. Date: Aug. 21, 2008

(54) TWO-CONSTITUENT POLYURETHANE COMPOSITION HAVING HIGH EARLY STRENGTH

(75) Inventors: Urs Burckhardt, Zurich (CH); Ursula Stadelmann, Zurich (CH); Martin Konstanzer, Zurich (CH)

Correspondence Address: OLIFF & BERRIDGE, PLC, P.O. BOX 320850, ALEXANDRIA, VA, 22320-4850, US

(73) Assignee: SIKA TECHNOLOGY AG, Baar (CH)

(21) Appl. No.: 12/056,043

(22) Filed: Mar. 26, 2008

Related U.S. Application Data
(63) Continuation of application No. 11/470,588, filed on Sep. 6, 2006, now abandoned.
Application No. 11/470,588 is a continuation of application No. 10/501,074, filed on Sep. 22, 2005, now abandoned.

(30) Foreign Application Priority Data
Jan. 18, 2002 (EP) 02001289.4
Jul. 26, 2002 (EP) 02016729.2
Jul. 26, 2002 (EP) 02016755.7

(51) Int. Cl. B05D 1/00; C08L 61/00; C08L 67/00; B05D 3/02

(52) U.S. Cl. 427/393.5; 524/542; 524/539

(57) ABSTRACT

The invention relates to a two-constituent composition, wherein the first constituent (A) contains at least one polyurethane prepolymer which has isocyanate end groups and is produced from at least one aromatic polyisocyanate and at least one polyol, and at least one polyaldimine which can be obtained from at least one polyamine having aliphatic primary amino groups and at least one aldehyde which, in position α in relation to the carbonyl group, does not have any C—H groups. The second constituent (B) contains water which is bound to a carrier material. The inventive composition is characterised in that it exhibits a high early strength, and hardens quickly, thus not forming any bubbles.

This is a Continuation Application of application Ser. No. 11/470,588, filed on Sep. 6, 2006, which is a Continuation of application Ser. No. 10/501,074, filed Sep. 22, 2005 (abandoned), which in turn is a National Phase of Application No. PCT/EP03/00456, filed Jan. 17, 2003. The disclosures of the prior applications are hereby incorporated by reference herein in their entireties.

### TECHNICAL FIELD

The invention relates to two-component polyurethane compositions having a high early strength, composed of a first component (A) which also cures solely by reaction with atmospheric moisture, and a second component (B), which comprises water bound to a carrier material.

### PRIOR ART

The uses to which polyurethane compositions are put include a variety of adhesive bonds, seals and coatings. They are especially suitable for adhesive bonds or seals which require elasticity in the bond. For certain adhesive applications it is necessary for the bond to be subjected to a mechanical load just shortly after the adhesive has been applied; for example, because the bonded components are to be moved, or because some fixing is to be removed. In order to allow such early loads it is advantageous for an adhesive to have a high early strength; that is, the bond can be loaded to a certain degree even before curing is complete. Practical requirements on the early strength in respect of timepoint and mechanical load vary considerably with each application and depend on the specific manufacturing operation, on the weight of the bonded components and on the nature of the mechanical load.

With conventional two-component polyurethane systems high early strengths are achievable, especially when they contain primary or secondary amino groups in their second component. Two-component polyurethane compositions of this kind, however, are inconvenient to deal with, since on the one hand the defined mixing ratio of the two components must be observed very precisely and on the other hand the components must be mixed thoroughly and homogeneously. Otherwise the result is a deficient adhesive bond, which fails by far to attain the required strengths, or the system does not cure at all. Owing to the very high reactivity of the amino groups toward the isocyanate groups, the mixing of the two components, moreover, must be very rapid and efficient and does not allow any interruptions to the operation, since otherwise the mixer becomes clogged. The high reactivity also results in very rapid curing and hence in very short processing times (pot lives and open times), as a result of which any careful processing, depending on application, may be made more difficult or even impossible.

Easier to deal with are one-component polyurethane compositions. They comprise polyurethane prepolymers containing isocyanate end groups, which on contact with water in the form of atmospheric moisture react and so crosslink. Since curing is accomplished by contact with atmospheric moisture, these systems cure from the outside in, the curing rate decreasing toward the inside, since the water that is needed for curing has to diffuse through the increasingly thick layer of cured material. Owing to the relatively slow curing, the early strengths achievable with such one-component polyurethane compositions are unsatisfactory.

In order to solve the problem of the low level of water availability and hence the slow curing in a one-component polyurethane composition, systems were developed in which water, in the form of a water-containing second component, is mixed into a one-component polyurethane composition, described for example in EP 0 678 544. Although such systems do then have a distinctly increased curing rate, they have the serious drawback that in the course of curing they display a tendency to form disruptive bubbles, which may adversely affect the strength and the adhesion behavior of, for example, an adhesive bond. The appearance of bubbles is a general problem of isocyanate-based systems which cure with water, since the reaction between isocyanate groups and water releases carbon dioxide gas (CO₂). In the case of rapid release and inadequate solubility in the composition or excessively slow diffusion through the composition to the outside, this gas may accumulate in the form of gas bubbles, causing the cured material to foam to a greater or lesser degree, which often leads to sensitive disruption of the service properties.

U.S. Pat. No. 4,469,857 describes a two-component polyurethane system comprising in the isocyanate-based first component, which also cures solely by reaction with atmospheric moisture, polyenamines as blocked curing agents. Polyenamines, however, generally have the drawback that the storage stability in combination with isocyanate compounds is inadequate, particularly in combination with reactive aromatic isocyanates such as MDI and TDI, for example.

U.S. Pat. No. 5,194,488 describes a two-component polyurethane sealant for the adhesive bonding of automobile windows, which features rapid curing and a relatively slow processing time, and which is composed of a first, isocyanate-containing component with a blocked curing agent and of a second, water-containing component which releases the water in a retarded fashion. The blocked curing agent used is preferably an amine-filled molecular sieve or an enamine or ketimine or oxazolidine. The use of amine-filled molecular sieves as a blocked curing agent in polyurethane compositions containing isocyanate groups leads, from experience, to distinct formation of bubbles in the course of curing. The use of molecular sieves, moreover, offers only little room for maneuver in the selection of the polyamines that can be employed, since their size has to be matched to the pore size of the molecular sieve. Consequently only small diamines such as ethylenediamine come into consideration. Such amines exert a strong influence on the mechanical properties of the cured composition; the rigidity (elasticity modulus) in particular is sharply increased, which is undesirable particularly for flexible adhesive bonds or seals. The use of enamines or ketimines or oxazolidines as blocked curing agents in isocyanate-based systems, on the other hand, leads to problems with the storage stability of the first, isocyanate-containing component, particularly if reactive aromatic isocyanates such as MDI and TDI, for example, are present.

Practical systems in which a water-containing or water-releasing paste is mixed to a polyurethane composition which also cures solely with moisture and contains aromatic isocyanates, and which do not form bubbles on curing and have a high early strength, are unknown to date.

### DEPICTION OF THE INVENTION

It is an object of the present invention to provide a two-component polyurethane composition which has a high early strength, cures rapidly and yet does not form bubbles.

Surprisingly, it has been found that this is achievable by means of a two-component polyurethane composition in which the first component (A) comprises at least one polyurethane prepolymer containing isocyanate end groups, which is prepared from at least one aromatic polyisocyanate and at least one polyol, and at least one polyaldimine which is obtainable from an at least one polyamine containing aliphatic primary amino groups and at least one aldehyde which does not contain a C—H moiety positioned α to the carbonyl group, and in which the second component (B) comprises water bound to a carrier material.

With a two-component polyurethane composition of this kind it is possible to formulate practical systems which achieve a high early strength and cure rapidly without producing bubbles. Additionally and unexpectedly it has been found that despite their rapid curing such two-component polyurethane compositions exhibit excellent adhesion to a variety of solids surfaces. This is all the more surprising on account of the fact that rapid-curing reactive polyurethane systems, experience suggests, exhibit much poorer adhesion than those which cure slowly. Furthermore, the first component (A) alone forms a practical one-component polyurethane composition which can be cured by atmospheric moisture. The mechanical properties after curing of the one-component polyurethane composition cured slowly by atmospheric moisture, corresponding to the first component (A) of the two-component polyurethane composition of the invention, are of comparable quality with those of the two-component composition of the invention in which water bound to a carrier material results in rapid curing.

### WAY OF IMPLEMENTING THE INVENTION

The present invention relates to a two-component composition in which the first component (A) comprises at least one polyurethane prepolymer containing isocyanate end groups, which is prepared from at least one aromatic polyisocyanate and at least one polyol, and at least one polyaldimine which is obtainable from at least one polyamine containing aliphatic primary amino groups and at least one aldehyde which does not contain a C—H moiety positioned α to the carbonyl group, and in which the second component (B) comprises water bound to a carrier material.

“Poly” in “polyaldimine”, “polyol”, “polyisocyanate”, “polyamine” refers in the present document to molecules which formally contain two or more of the respective functional groups.

The term “polyurethane” embraces in the present document all polymers which are prepared by the diisocyanate polyaddition process. This also includes those polymers which are almost or entirely free from urethane groups, such as polyether-polyurethanes, polyester-polyurethanes, polyether-polyureas, polyureas, polyester-polyureas, polyisocyanurates, polycarbodiimides, and so on.

The term “polyamines containing aliphatic primary amino groups” refers always in the present document to compounds which formally contain two or more NH₂ groups attached to an aliphatic, cycloaliphatic or arylaliphatic radical. They are therefore different from the aromatic amines in which the amino groups are attached directly to an aromatic radical, such as in aniline or 2-aminopyridine, for example.

The term “aldehyde which does not contain any C—H moiety positioned α to the carbonyl group” refers in the present document to an aldehyde or a compound containing formyl groups in which the carbon atom positioned α (position 2) to the formyl group does not have a bond to a hydrogen atom. In other words, the aldehyde in question is an aldehyde which is not enolizable, i.e., which does not exhibit keto-enol tautomerism.

The polyaldimine is preparable from at least one polyamine containing aliphatic primary amino groups and at least one aldehyde by a condensation reaction with elimination of water. Condensation reactions of this kind are very well known and are described in, for example, Houben-Weyl, “Methoden der organischen Chemie”, Vol. XI/2, page 73 ff.

Suitable polyamines containing aliphatic primary amino groups for preparing the polyaldimine include the polyamines which are known in polyurethane chemistry, such as are used, among other things, for two-component polyurethanes. Examples that may be mentioned include the following: aliphatic polyamines such as ethylenediamine, 1,2- and 1,3-propanediamine, 2-methyl-1,2-propanediamine, 2,2-dimethyl-1,3-propanediamine, 1,3- and 1,4-butanediamine, 1,3- and 1,5-pentanediamine, 1,6-hexamethylenediamine, 2,2,4- and 2,4,4-trimethylhexamethylenediamine and mixtures thereof, 1,7-heptanediamine, 1,8-octanediamine, 4-aminomethyl-1,8-octanediamine, 1,9-nonanediamine, 1,10-decanediamine, 1,11-undecanediamine, 1,12-dodecanediamine, methylbis(3-aminopropyl)amine, 1,5-diamino-2-methylpentane (MPMD), 1,3-diaminopentane (DAMP), 2,5-dimethyl-1,6-hexamethylenediamine, cycloaliphatic polyamines such as 1,3- and 1,4-diaminocyclohexane, bis(4-aminocyclohexyl)methane, bis(4-amino-3-methylcyclohexyl)methane, bis(4-amino-3-ethylcyclohexyl)methane, bis(4-amino-3,5-dimethylcyclohexyl)methane, 1-amino-3-aminomethyl-3,5,5-trimethylcyclohexane (=isophoronediamine or IPDA), 2- and 4-methyl-1,3-diaminocyclohexane and mixtures thereof, 1,3- and 1,4-bis(aminomethyl)cyclohexane, 1-cyclohexylamino-3-aminopropane, 2,5(2,6)-bis(aminomethyl)bicyclo[2.2.1]heptane (NBDA, produced by Mitsui Chemicals), 3(4),8(9)-bis(aminomethyl)tricyclo[5.2.1.0^{2,6}]decane, 1,4-diamino-2,2,6-trimethylcyclohexane (TMCDA), 3,9-bis(3-aminopropyl)-2,4,8,10-tetraoxaspiro[5.5]undecane, 1,3- and 1,4-xylylenediamine, aliphatic polyamines containing ether groups, such as bis(2-aminoethyl)ether, 4,7-dioxadecane-1,10-diamine, 4,9-dioxadodecane-1,12-diamine and higher oligomers thereof, polyoxyalkylene-polyamines having in theory two or three amino groups, obtainable for example under the name Jeffamine® (produced by Huntsman Chemicals), and mixtures of the aforementioned polyamines.

Preferred polyamines are 1,6-hexamethylenediamine, MPMD, DAMP, IPDA, 4-aminomethyl-1,8-octanediamine, 1,3-xylylenediamine, 1,3-bis(aminomethyl)cyclohexane, bis(4-aminocyclohexyl)methane, bis(4-amino-3-methylcyclohexyl)methane, 3(4),8(9)-bis(aminomethyl)tricyclo[5.2.1.0²,6]decane, 1,4-diamino-2,2,6-trimethylcyclohexane, polyoxyalkylene-polyamines having theoretically two or three amino groups, especially Jeffamine® EDR-148, Jeffamine® D-230, Jeffamine® D-400 and Jeffamine® T-403, and, in particular, mixtures of two or more of the aforementioned polyamines.

The polyaldimine present in the composition of the invention is obtainable from at least one polyamine containing aliphatic primary amino groups and from at least one aldehyde. It is an essential feature of the invention that said aldehyde does not contain a C—H moiety positioned α to the carbonyl group. Suitable aldehydes, accordingly, are all those which are unable to enolize and, correspondingly, the polyaldimines prepared from them are unable to form enamines.

In a first embodiment aldehydes of the following formula (I) are used:

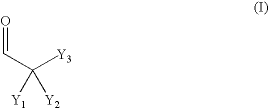

On the one hand Y₁, Y₂ and Y₃ here independently of one another are alkyl or arylalkyl groups each of which may optionally be substituted.

On the other hand Y₁ can be an oxy group O—Y₄, Y₄ being an optionally substituted alkyl or arylalkyl or aryl group, and Y₂ and Y₃ independently of one another are alkyl or arylalkyl groups, each of which may optionally be substituted.

Finally Y₁ and Y₂ can be connected to one another to form a carbocyclic or heterocyclic ring having a ring size of between 5 and 8, preferably 6, atoms and optionally having one or two singly unsaturated bonds.

Examples of aldehydes of the formula (I) are 2,2-dimethylpropanal, 2-cyclopentylpropanal, 2-cyclohexylpropanal, 2,2-diethylbutanal, 3-methoxy- and 3-ethoxy- and 3-propoxy- and 3-isopropoxy and 3-butoxy-2,2-dimethylpropanal, 3-(2-ethylhexoxy)-2,2-dimethylpropanal, esters of 2-formyl-2-methylpropionic acid and alcohols such as methanol, ethanol, propanol, isopropanol, butanol and 2-ethylhexanol, ethers of 2-hydroxy-2-methylpropanal and alcohols such as methanol, ethanol, propanol, isopropanol, butanol and 2-ethylhexanol, esters of 2-hydroxy-2-methylpropanal and carboxylic acids such as formic acid, acetic acid, propionic acid, butyric acid, isobutyric acid and 2-ethylhexanoic acid.

In another embodiment aldehydes of the following formula (II) are used:

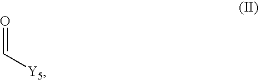

where Y₅ is an optionally substituted ary or heteroaryl group which has a ring size of between 5 and 8, preferably 6, atoms. The heteroatoms in the heteroaryl ring are preferably nitrogen and oxygen.

Examples of aldehydes of the formula (II) are benzaldehyde, 2- and 3- and 4-tolualdehyde, 4-ethyl- and 4-propyl- and 4-isopropyl and 4-butyl-benzaldehyde, 2,4-dimethylbenzaldehyde, 2,4,5-trimethylbenzaldehyde, 4-acetoxybenzaldehyde, 4-anisaldehyde, 4-ethoxybenzaldehyde, 2- and 3- and 4-formylpyridine, 2-furfuraldehyde, 1- and 2-naphthylaldehyde, 3- and 4-phenyloxy-benzaldehyde; quinoline-2-carbaldehyde and its 3, 4, 5, 6, 7 and 8 position isomers, anthracene-9-carbaldehyde.

In a further embodiment aldehydes of the following formula (III) are used:

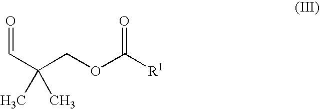

For R¹ there are 3 possibilities:

R¹ firstly is a linear or branched alkyl chain, optionally containing at least one heteroatom, in particular containing at least one ether oxygen, or is a mono- or polyunsaturated linear or branched hydrocarbon chain.

R¹ secondly is a radical of the following formula (IV):

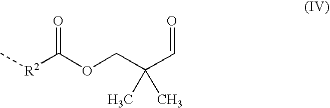

R¹ finally is a radical of the following formula (V):

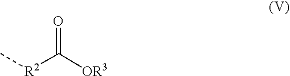

R² is a linear or branched or cyclic alkylene chain, optionally containing at least one heteroatom, in particular containing at least one ether oxygen, or is a mono- or polyunsaturated linear or branched or cyclic hydrocarbon chain.

R³ is a linear or branched alkyl chain.

Examples of preferred aldehydes of the formula (III) are 2,2-dimethyl-3-formoxypropanal, 2,2-dimethyl-3-acetoxypropanal, 2,2-dimethyl-3-propionoxypropanal, 2,2-dimethyl-3-butyroxypropanal, 2,2-dimethyl-3-iso-butyroxypropanal, 2,2-dimethyl-3-(2-ethylhexanoyloxy)propanal and the aldehydes set out below as particularly preferred.

In one particularly preferred embodiment aldehydes of the formula (III) are used whose radicals R¹, R² and R³ are restricted as follows:

R¹ is a linear or branched alkyl chain having 11 to 30 carbon atoms, optionally containing at least one heteroatom, in particular containing at least one ether oxygen, or is a mono- or polyunsaturated linear or branched hydrocarbon chain having 11 to 30 carbon atoms, or is a radical of the formula (IV) or (V).

R² here is a linear or branched or cyclic alkylene chain having 2 to 16 carbon atoms, optionally containing at least one heteroatom, in particular containing at least one ether oxygen, or is a mono- or polyunsaturated linear or branched or cyclic hydrocarbon chain having 2 to 16 carbon atoms.

R³ here is a linear or branched alkyl chain having 1 to 8 carbon atoms.

This embodiment of the invention makes it possible to prepare polyurethane compositions without a disruptive odor. This is extremely advantageous for applications in the interior of buildings and vehicles or in the case of application over a large surface area.

In one preferred preparation method of the aldehyde of the formula (III) 3-hydroxypivalaldehyde, which can be prepared for example from formaldehyde (or paraformaldehyde) and isobutyraldehyde, in situ if desired, is reacted with a carboxylic acid, in particular a long-chain fatty acid, to form the corresponding ester, specifically either with carboxylic acid R¹—COOH to form the corresponding carboxylic ester of 3-hydroxypivalaldehyde; and/or with a dicarboxylic acid monoalkyl ester HOOC—R²—COOR³ to form the aldehyde of the formula (III) with the radical R¹ according to formula (V); and/or with a dicarboxylic acid HOOC—R²—COOH to form the aldehyde of the formula (III), in this case a dialdehyde, with the radical R¹ according to formula (IV). The formulae (IV) and (V) and R¹, R² and R³ in this context have the signification already described. This esterification can take place without the use of solvents by known methods, described for example in Houben-Weyl, “Methoden der organischen Chemie”, Vol. VIII, pages 516-528.

In the case of the use of dicarboxylic acids a mixture of the aldehydes of the formula (III) with the radicals R¹ according to formula (IV) and according to formula (V) is obtained if, for example, first some of the carboxyl groups are esterified with 3-hydroxypivalaldehyde and thereafter the remaining carboxylic acid groups are esterified with an alkyl alcohol (R³—OH). A mixture of this kind can be used further directly to prepare the polyaldimine.

Suitable carboxylic acids for esterification with 3-hydroxypivalaldehyde include both short-chain and long-chain carboxylic acids. Examples of suitable short-chain carboxylic acids are formic acid, acetic acid, propionic acid, butyric acid, isobutyric acid and 2-ethylcaproic acid. Particularly suitable are long-chain carboxylic acids such as for example: lauric acid, tridecanoic acid, myristic acid, pentadecanoic acid, palmitic acid, margaric acid, stearic acid, nonadecanoic acid, arachidic acid, palmitoleic acid, oleic acid, erucic acid, inoleic acid, linolenic acid, elaeostearic acid, arachidonic acid, succinic acid, glutaric acid, adipic acid, pimelic acid, suberic acid, azelaic acid, sebacic acid, 1,12-dodecanedioic acid, maleic acid, fumaric acid, hexahydrophthalic acid, hexahydroisophthalic acid, hexahydroterephthalic acid, 3,6,9-trioxaundecanedioic acid and similar derivatives of polyethylene glycol, dehydrogenated ricinoleic acids, and fatty acids from the industrial hydrolysis of natural oils and fats, such as, for example, rapeseed oil, sunflower oil, linseed oil, olive oil, coconut oil, oil palm kernel oil and oil palm oil.

Preference is given to lauric acid, myristic acid, palmitic acid, stearic acid, oleic acid, linoleic acid, linolenic acid, succinic acid, adipic acid, azelaic acid and sebacic acid and to technical-grade fatty acid mixtures which comprise these acids.

The reaction of at least one polyamine containing aliphatic primary amino groups with at least one aldehyde of the formula (III) produces, for example, polyaldimines of the schematic formulae (VI) and (VII),

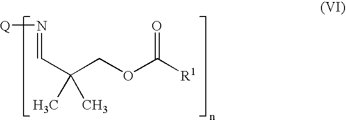

where n is 2, 3 or 4 and Q is intended to denote the radical of a polyamine containing aliphatic primary amino groups after all of the primary amino groups have been removed; and

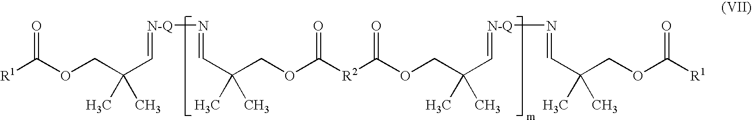

where m is an integer from 0 to 10 and Q is identical or different at each occurrence in the same molecule and is intended in each case to denote the radical of a polyamine containing aliphatic primary amino groups after all of the primary amino groups have been removed. The radicals R¹ and R² in the formulae (IV) and (VII) have the signification already described.

If a dialdehyde of the formula (III) with the radical R¹ according to formula (IV) is used for preparing a polyaldimine then it is advantageously used either in a mixture with a monoaldehyde of the formula (III), specifically in a proportion such that, for the polyaldimine of formula (VII), average values for m in the range from 1 to 10 are obtained; or it is metered in such a way that there is an excess of aldehyde groups in relation to the amino groups in the preparation of the polyaldimine, the aldehyde excess being chosen such that for the polyaldimine of formula (VII) average values for m likewise in the range from 1 to 10 are obtained. In both ways a mixture of oligomeric polyaldimines having a readily manipulable viscosity is obtained.

As polyaldimine it is also possible to use mixtures of different polyaldimines, including in particular mixtures of different polyaldimines prepared by means of different polyamines containing primary aliphatic amino groups, reacted with different or the same aldehydes of the formula (I), (II) or (III). It may also be entirely advantageous to prepare mixtures of polyaldimines by using mixtures of polyamines having a different number of primary aliphatic amino groups.

For preparing the polyaldimine the aldehyde is used stoichiometrically or in a stoichiometric excess in relation to the primary amino groups of the polyamine.

The two-component polyurethane composition of the invention comprises in the first component (A) at least one polyurethane prepolymer having isocyanate end groups, prepared from at least one aromatic polyisocyanate and at least one polyol.

This reaction can be effected by reacting the polyol and the polyisocyanate by customary methods, at temperatures from 50° C. to 100° C. for example, with or without the use of appropriate catalysts, the polyisocyanate being metered such that its isocyanate groups are in stoichiometric excess in relation to the hydroxyl groups of the polyol. The excess of polyisocyanate is chosen so that in the resultant polyurethane prepolymer after all of the polyol's hydroxyl groups have reacted there remains a free isocyanate group content of from 0.1 to 15% by weight, preferably from 0.5 to 5% by weight, based on the overall polyurethane prepolymer. If desired the polyurethane prepolymer can be prepared using solvents or plasticizers, the solvents or plasticizers used containing no isocyanate-reactive groups.

As polyols for preparing the polyurethane prepolymer it is possible for example to use the following commercially customary polyols or any desired mixtures thereof:

polyoxyalkylene polyols, also called polyether polyols, which are polymerization products of ethylene oxide, 1,2-propylene oxide, 1,2- or 2,3-butylene oxide, tetrahydrofuran or mixtures thereof, possibly polymerized with the aid of a starter molecule containing two or more active hydrogen atoms, such as water, ammonia or compounds containing two or more OH or NH groups, for example, such as 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, bisphenol A, hydrogenated bisphenol A, 1,1,1-trimethylolethane, 1,1,1-trimethylolpropane, glycerol, aniline and also mixtures of the aforementioned compounds. Use may be made not only of polyoxyalkylene polyols which have a low degree of unsaturation (measured in accordance with ASTM D-2849-69 and stated in milliequivalent of unsaturation per gram of polyol (meq/g)), prepared for example by means of what are called double metal cyanide complex catalysts (DMC catalysts), but also of polyoxyalkylene polyols having a higher degree of unsaturation, prepared for example by means of anionic catalysts such as NaOH, KOH or alkali metal alkoxides.

Particular suitability is possessed by polyoxyalkylene diols or polyoxyalkylene triols, especially polyoxypropylene diols or polyoxypropylene triols.

Of specific suitability are polyoxyalkylene diols or polyoxyalkylene triols having a degree of unsaturation deeper than 0.02 meq/g and having a molecular weight in the range from 1000 to 30 000 g/mol, and also polyoxypropylene diols and triols having a molecular weight of from 400 to 8000 g/mol.

Likewise particularly suitable are what are called “EO-endcapped” (ethylene oxide-endcapped) polyoxypropylene diols or triols. The latter are specific polyoxypropylene-polyoxyethylene polyols obtained for example by alkoxylating straight polyoxypropylene polyols with ethylene oxide following polypropoxylation, and therefore having primary hydroxyl groups. By “molecular weight” or “molar weight” is meant in the present document always the molecular weight average Mₙ.

hydroxy-functional polybutadienes.

polyester polyols prepared for example from dihydric or trihydric alcohols such as, for example, 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane or mixtures of the aforementioned alcohols with organic dicarboxylic acids or their anhydrides or esters, such as succinic acid, glutaric acid, adipic acid, suberic acid, sebacic acid, dodedanedicarboxylic acid, maleic acid, fumaric acid, phthalic acid, isophthalic acid, terephthalic acid and hexahydrophthalic acid, for example, or mixtures of the aforementioned acids, and also polyester polyols formed from lactones such as ε-caprolactone, for example.

polycarbonate polyols such as are obtainable by reacting, for example, the abovementioned alcohols—those use to synthesize the polyester polyols—with dialkyl carbonates, diaryl carbonates or phosgene.

These stated polyols have an average molecular weight of from 250 to 30 000 g/mol and an average OH functionality in the range from 1.6 to 3.

In addition to these stated polyols it is possible as well to use low molecular weight dihydric or polyhydric alcohols such as, for example, 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, hydrogenated bisphenol A, dimeric fatty alcohols, 1,1,1-trimethylolethane, 1,1,1-trimethylolpropane, glycerol, pentaerythritol, sugar alcohols and other higher polyhydric alcohols, low molecular mass alkoxylation products of the aforementioned dihydric and polyhydric alcohols, and mixtures of the aforementioned alcohols, in preparing the polyurethane prepolymer.

The polyurethane prepolymer is prepared using commercially customary aromatic polyisocyanates. Examples that may be mentioned include the following polyisocyanates, very well known in polyurethane chemistry: 2,4- and 2,6-tolylene diisocyanate (TDI) and any mixtures of these isomers, 4,4′-diphenylmethane diisocyanate (MDI), the positionally isomeric diphenylmethane diisocyanates, 1,3- and 1,4-phenylene diisocyanate, oligomers and polymers of the aforementioned isocyanates, and any desired mixtures of the aforementioned isocyanates. Particular preference is given to MDI and TDI.

The polyurethane prepolymer and the polyaldimine are combined with one another, the polyaldimine being metered in an amount of from 0.1 to 1.1 equivalents of aldimine groups per equivalent of isocyanate groups of the polyurethane prepolymer. Additionally it is possible to add a catalyst for the hydrolysis of the polyaldimine, an example being an organic carboxylic acid such as benzoic acid or salicylic acid, an organic carboxylic anhydride such as phthalic anhydride or hexahydrophthalic anhydride, a silyl ester of organic carboxylic acids, an organic sulfonic acid such as p-toluenesulfonic acid or 4-dodecylbenzenesulfonic acid, or another organic or inorganic acid, or mixtures of the aforementioned acids.

The composition of the invention comprises a second component (B) which comprises water bound to a carrier material. It is a feature essential to the invention that the water cannot be used alone. It must be bound to a carrier material. The binding, however, must be reversible; in other words, the water must be accessible for the reaction with the polyaldimine.

The mixing of the second component (B) into the first component (A) leads to immediate availability of water in the composition as a whole, as a result of which said composition cures very much more rapidly than a one-component composition. Since the proper curing of the isocyanate-containing polyurethane with the polyaldimine under the influence of water is not disrupted by a stoichiometric excess of the water in relation to the isocyanate groups and aldimine groups, and since a substoichiometric amount of water can be compensated by aftercuring via atmospheric moisture, the functioning of the system is not very dependent on the observance of a particular mixing ratio between the two components (A) and (B), such as is the case in a conventional two-component polyurethane system. For the same reasons it is also not necessary for the mixing of the two components to be entirely homogeneous. Accordingly the two-component system of the invention is much easier to manipulate. It can be applied, for example, using apparatus which would be unsuitable for conventional two-component polyurethane systems.

Suitable carrier materials for component (B) may be hydrates or aquo complexes, especially inorganic compounds having water bound in coordinative fashion or as water of crystallization. Examples of such hydrates are Na₂SO₄.10H₂O, CaSO₄.2H₂O, CaSO₄.½H₂O, Na₂B₄O₇.10H₂O, MgSO₄.7H₂O.

Further suitable carrier materials include porous materials which enclose water in cavities. In particular such materials are specific silicates and zeolites. Particular suitability is possessed by kieselguhr and molecular sieves. The size of the cavities is to be chosen such that they are optimum for the accommodation of water. Consequently molecular sieves with a pore size of 4 Å are found particularly suitable.

A further possibility of suitable carrier materials are carrier materials which accommodate water in nonstoichiometric amounts and have a pasty consistency or form gels. The carrier materials may be organic or inorganic. Examples thereof are silica gels, clays, such as montmorillonite, bentonites, hectorite or polysaccharides, such as cellulose and starch, or polyacrylic acids, which are also known by the name “superabsorbents” and are employed, for example, in the production of hygiene articles. Also suitable are carrier materials which carry ionic groups. Particularly preferred carrier materials are polyurethane polymers containing carboxyl groups or sulfonic acid groups as side chains and, respectively, their salts, especially their ammonium salts. These carrier materials are able to accommodate and bind water until their water uptake capacity is exhausted.

The particularly preferred polyurethane polymers containing carboxyl groups or sulfonic acid groups and, respectively, salts thereof as side chains may be obtained for example from polyisocyanates and polyols which contain carboxylic or sulfonic acid groups. The acid groups can be subsequently neutralized, in the fully reacted state, for example, with bases, especially tertiary amines. The properties of the carrier material are heavily dependent on the functional polyols and polyisocyanates that are used. Account should be taken in particular of the hydrophilicity or hydrophobicity of the isocyanates and polyols chosen. It has been found that short-chain polyols in particular produce very suitable carrier materials.

For the composition of the invention it is important that the amount of water present in the second component (B) does not exceed the accommodation capacity of the carrier material. The second component (B) must always—even following prolonged storage—be in the form of a homogeneous gel or homogeneous paste and must not deposit any substantial quantities of liquid water.

For rapid reactions preference is given to those carrier materials which are able to deliver the bound water rapidly. For this reason, organic polymers containing ionic groups, in particular, are very suitable carrier materials.

The water is released preferably at room temperature and below. It can also be desirable, however, for the release to take place only at higher temperatures. The release temperature can be influenced greatly by the choice of carrier material.

The ratio of equivalents of water used to equivalents of aldimine groups used is preferably from 0.5 to 10.0, in particular from 1.0 to 5.0.

The polyurethane compositions described may further comprise, inter alia, the following auxiliaries and additives well known in the polyurethane industry:

plasticizers, examples being esters of organic carboxylic acids or their anhydrides, phthalates, such as dioctyl phthalate or diisodecyl phthalate, adipates, such as dioctyl adipate, sebacates, organic phosphoric and sulfonic esters, polybutenes and other compounds not reactive with isocyanates; reactive diluents and crosslinkers, examples being aliphatic isocyanates such as 1,6-hexamethylene diisocyanate, 2,2,4- and 2,4,4-trimethyl-1,6-hexamethylene diisocyanate, 1,12-dodecamethylene diisocyanate, cyclohexane 1,3- and 1,4-diisocyanate and any desired mixtures of these isomers, 1-isocyanato-3,3,5-trimethyl-5-isocyanatomethylcyclohexane (=isophorone diisocyanate or IPDI), perhydro-2,4′- and -4,4′-diphenylmethane diisocyanate, 1,3- and 1,4-tetramethylxylylene diisocyanate, isocyanurates of these isocyanates, oligomers and polymers of these isocyanates and also their adducts with polyols; solvents; organic and inorganic fillers, such as ground or precipitated calcium carbonates, for example, with or without a coating of stearates, especially finely divided coated calcium carbonate, carbon blacks, kaolins, aluminas, silicas and PVC powders or hollow beads; fibers, of polyethylene for example; pigments; catalysts such as organotin compounds, for example, such as dibutyltin dilaurate, dibutyltin dichloride, dibutyltin diacetylacetonate, organobismuth compounds or bismuth complexes, or compounds containing amine groups, such as 2,2′-dimorpholinodiethyl ether, or other catalysts customary in polyurethane chemistry for the reaction of isocyanate groups; rheology modifiers such as thickeners, examples being urea compounds, polyamide waxes, bentonites or pyrogenic silicas; adhesion promoters, especially silanes such as epoxysilanes, vinylsilanes, isocyanatosilanes and aminosilanes that are reacted with aldehydes to form aldiminosilanes, and also oligomeric forms of these silanes; dryers such as p-tosyl isocyanate and other reactive isocyanates, orthoformic esters, calcium oxide or molecular sieves; stabilizers against heat, light and UV radiation; flame retardants; surface-active substances such as wetting agents, leveling agents, devolatilizers or defoamers; fungicides or substances which inhibit fungal growth; and further substances commonly used in the polyurethane industry, the skilled worker being clearly aware of whether these additional substances are suitable for both or only for one in each case of the two components (A) and (B).

The two-component polyurethane composition of the invention also allows in particular the formulation of white compositions which cure rapidly and without the formation of bubbles. It is known that white systems formulated in accordance with the prior art often exhibit extremely severe bubble formation.

The two components, particularly the first component (A), are prepared and stored in the absence of moisture. Separately from one another the two components are storage-stable; that is, they can be kept in suitable packaging or a suitable arrangement, such as in a drum, a pouch or a cartridge, for example, for a period of several months up to one year prior to their use, or longer, without losing their capacity for use. In one embodiment the second component (B) can be kept in a container such as is described later on below, which is integrated in a metering attachment.

It is also possible for the two components to be charged to and stored in containers separated from one another by way of partitioning walls. Examples of such containers are coaxial cartridges or twin cartridges.

When the two components (A) and (B) are mixed the polyaldimine hydrolyzes to an aldehyde and a polyamine, the latter reacting with the isocyanate-group-containing polyurethane prepolymer and so at least partially curing it.

The mixing of the two components (A) and (B) takes place advantageously continuously during the application. In one preferred embodiment the mixing of the two components (A) and (B) takes place by means of a metering attachment which comprises two interengaging metering rotors. Preferred metering attachments of this kind are described in detail in patent EP 0 749 530. The metering attachment is preferably mounted, for relatively small applications, onto a commercially customary cartridge, which comprises the first component (A), while the second component (B) is located in a container which is integrated in the metering attachment. On application, metering and mixing take place in this metering attachment, which is operated passively by the action of pressure on the cartridge, by means for example of a commercially customary cartridge press. For improved commixing it is possible in addition to mount a static mixer at the exit aperture of this metering attachment.

For industrial applications, in contrast, it is advantageous to employ conveying of the two components (A) and (B) from drums or hobbocks. In this case the two components (A) and (B) are advantageously mixed with a metering attachment which differs from the metering attachment described above essentially in that it has a hose connection for the second component (B).

In one embodiment the mixing of the two components (A) and (B) of the polyurethane composition is essentially homogeneous.

In another embodiment the mixing of the two components (A) and (B) of the polyurethane composition is essentially layerlike.

Typical application takes place by first mixing the two components (A) and (B) of the polyurethane composition as described and then contacting the mixed polyurethane composition with at least one solids surface and curing it. Contacting of the solids surface takes place typically in the form of application of a bead to the surface.

Crosslinking begins immediately after the two components (A) and (B) have been mixed. Additional water, which may influence curing, may penetrate the applied polyurethane composition from the environment, in the form of atmospheric moisture, for example, following application.

If the polyaldimine is used in excess, i.e., if the chosen ratio of the aldimine groups to the isocyanate groups is substoichiometric, then the excess isocyanate groups react with the water present from the second component (B) or with atmospheric moisture.

The reaction of the isocyanate-group-containing polyurethane prepolymer with the hydrolyzing polyaldimine need not necessarily take place by way of the polyamine. It will be appreciated that reactions with intermediates of the hydrolysis of the polyaldimine to form the polyamine are also possible. For example, it is conceivable for the hydrolyzing polyaldimine to react in the form of a hemiaminal directly with the isocyanate-group-containing polyurethane prepolymer.

As a consequence of the reactions described above the polyurethane composition cures.

The polyurethane composition described is notable for outstanding early strength and rapid, bubble-free cure through volume and exhibits extremely good adhesion to a variety of solids surfaces, which in view of the very rapid curing, is no small matter, given that experience tells that rapid-curing polyurethane compositions have a propensity to weaknesses in their development of adhesion. The polyurethane composition described possesses, moreover, in the cured state outstanding mechanical properties. These are comparable with the mechanical properties of a corresponding one-component polyurethane composition slowly cured by atmospheric moisture alone. The cured two-component polyurethane composition possesses high elongation and a high tensile strength in conjunction with elasticity moduli which can be adapted to the requirements of the particular application by varying the components used, such as the polyols, polyisocyanates and polyamines, within a wide range.

In one preferred embodiment the aldehydes which are eliminated from polyaldimine in the course of its hydrolysis are distinguished by the fact that in view of their high vapor pressure they remain in the cured polyurethane composition and that they do not give rise to any disruptive odor in so doing. Where long-chain fatty acids are used, the hydrophobic fatty acid residue has the effect of lowering the water absorption of the cured polyurethane composition, thereby increasing the resistance of the polyurethane material toward hydrolysis. A hydrophobic fatty acid residue, moreover, offers effective protection against the leaching of the aldehydes from the cured polyurethane composition on prolonged water contact. These polyurethane systems also have good light stability.

The polyurethane composition described is suitable as a sealant of any kind, for the sealing for example of joints in building, as an adhesive for the bonding of various substrates, for the bonding for example of components in the production of automobiles, rail vehicles, boats or other industrial products, and also as a coating or covering for various articles or variable solids surfaces.

Preferred coatings are protective applications, sealing coats, protective coatings and primer coatings. Particular preference among the coverings is given to floor coverings. Such coverings are produced by typically pouring a reactive composition onto the subfloor and leveling it, where it cures to form a floor covering. Floor coverings of this kind are used for example for offices, living areas, hospitals, schools, warehouses, car parks and other private or industrial applications. These applications involve large surface areas, which even in the case of outdoor applications can lead to occupational hygiene difficulties and/or instances of odor nuisance. The majority of floor coverings, moreover, are applied in the interior sector. In the case of floor coverings, therefore, the odor is generally a great problem.

The polyurethane composition is contacted at least partly with the surface of any desired substrate. Preference is given to uniform contacting in the form of a sealant or adhesive, a coating or a covering, specifically in the regions which for use require a connection in the form of an adhesive bond or seal or else whose substrate is to be covered over. It may well be necessary for the substrate or the article to be contacted to have to be subjected to physical and/or chemical pretreatment prior to contacting, by abrasion, sandblasting, brushing or the like, for example, or by treatment with cleaners, solvents, adhesion promoters, adhesion promoter solutions or primers, or the application of a tiecoat or a sealer.

### EXAMPLES

### Polyols Used

Acclaim® 4200 N (Bayer): linear polypropylene oxide polyol having a theoretical OH functionality of 2, an average molecular weight of about 4000, an OH number of about 28 mg KOH/g and a degree of unsaturation of about 0.005 meq/g.

Caradol® MD34-02 (Shell): nonlinear polypropylene oxide-polyethylene oxide polyol, ethylene oxide-terminated, having a theoretical OH functionality of 3, an average molecular weight of about 4900, an OH number of about 35 mg KOH/g and a degree of unsaturation of about 0.08 meq/g.

Caradol® ED56-11 (Shell): linear polypropylene oxide polyol having a theoretical OH functionality of 2, an average molecular weight of about 2000, an OH number of about 56 mg KOH/g.

### Preparation of the Polyaldimines

### Polyaldimine A1

A round-bottomed flask was charged with 62.0 g of α,ω-polyoxypropylenediamine (Jeffamine® D-230, Huntsman; amine content=8.22 mmol NH₂/g). With thorough cooling and vigorous stirring, 89.5 g of 2,2-dimethyl-3-isobutyroxypropanal were added from a dropping funnel. After 10 minutes of stirring the volatile constituents were distilled off. The reaction product thus obtained, which is liquid at room temperature, had an aldimine content, determined as the amine content, of 3.58 mmol NH₂/g.

### Polyaldimine A2

A round-bottomed flask was charged with 100.0 g of α,ω-polyoxypropylenediamine (Jeffamine® D-230, Huntsman; amine content 8.22 mmol NH₂/g). With thorough cooling and vigorous stirring, 75.0 g of isobutyraldehyde were added from a dropping funnel. After 12 hours of stirring the volatile constituents were distilled off. The reaction product thus obtained, which is liquid at room temperature, had an aldimine content, determined as the amine content, of 5.66 mmol NH₂/g.

### Polyaldimine A3

A round-bottomed flask with reflux condenser and water separator (Dean Stark) was charged with 40.5 g of formaldehyde (37% in water, methanol-free), 36.0 g of isobutyraldehyde, 100.0 g of lauric acid and 1.0 g of 4-toluenesulfonic acid and this initial charge was placed under a nitrogen atmosphere. The mixture was heated with vigorous stirring in an oil bath, whereupon water began to separate off. After four hours the apparatus was evacuated under a water jet vacuum. A total of around 35 mL of distillate were collected in the separator. The reaction mixture was cooled, and 48.6 g of α,ω-polyoxypropylenediamine (Jeffamine® D-230, Huntsman; amine content=8.22 mmol NH₂/g) were added from a dropping funnel. Thereafter the volatile constituents were distilled off completely. The reaction product obtained in this way, which is liquid at room temperature, had an aldimine content, determined as the amine content, of 2.17 mmol NH₂/g.

### Polyaldimine A4

A round-bottomed flask was charged with 100.0 of α,ω-polyoxypropylenediamine (Jeffamine® D-230, Huntsman; amine content=8.22 mmol NH₂/g). With thorough cooling and vigorous stirring, 91.0 g of benzaldehyde were added dropwise. Following the addition, the mixture was stirred at room temperature for 10 minutes and then the water was distilled off completely under a water jet vacuum. The liquid reaction product obtained in this way had an aldimine content, determined as the amine content, of 4.65 mmol NH₂/g.

### Polyaldimine A5

A round-bottomed flask was charged with 50.0 of 1,5-diamino-2-methylpentane (MPMD, DuPont; amine content=17.11 mmol NH₂ g). With thorough cooling and vigorous stirring, 76.0 g of 2,2-dimethylpropanal were added dropwise. Following the addition, the mixture was stirred at room temperature for 10 minutes and then the water was distilled off completely under a water jet vacuum. The reaction product obtained in this way had an aldimine content, determined as the amine content, of 7.86 mmol NH₂/g.

### Preparation of the Water-Containing Component (B)

An organic polymer containing ionic groups and having an average molecular weight of approximately 20 000 was prepared by polyaddition of isophorone diisocyanate (IPDI; Vestanat® IPDI, Degussa) with polyol Caradol® ED56-11 (Shell), aminoethylethanolamine and 2,2-bis(hydroxymethyl)propionic acid in N-methylpyrrolidone, followed by neutralization with triethylamine and addition of water up to a water content of 25% by weight. A homogeneous paste was obtained which even after prolonged storage remained unchanged and did not deposit any water.

The paste prepared in this way was used as the second component (B) for all of the examples 1 to 15 described below.

### Examples 1 to 7

Examples 1 to 7 demonstrate the preparation of two-component polyurethane compositions of the invention and their use as adhesives.

### a) Preparation of the First Component (A):

In a vacuum mixer 2500 g of prepolymer 1, 1000 g of prepolymer 2, 3500 g of kaolin, 2540 g of urea thickener, 50 g of 3-glycidyloxypropyltrimethoxysilane (Silquest® A-187, OSi Crompton) and 10 g of benzoic acid were processed in the absence of moisture to form a lump-free, homogeneous paste.

Prepolymers 1 and 2 were prepared as follows:

Pre-polymer 1: 1295 g of polyol Acclaim® 4200 N (Bayer), 2585 g of polyol Caradol® MD34-02 (Shell), 620 g of 4,4′-methylenediphenyl diisocyanate (MDI; Desmodur® 44 MC L, Bayer) and 500 g of diisodecyl phthalate (DIDP; Palatinol® Z, BASF) were reacted by a known method at 80° C. to form an NCO-terminated polyurethane prepolymer. The reaction product had a titrimetrically determined free isocyanate group content of 2.03% by weight.

Prepolymer 2: 1230 g of polyol Acclaim® 4200 N (Bayer), 615 g of polyol Caradol® MD34-02 (Shell) and 155 g of tolylene diisocyanate (TDI; Desmodur® T-80 P L, Bayer; 80:20 mixture of the 2,4 and 2,6 isomers) were reacted by a known method at 80° C. to form an NCO-terminated prepolymer. The reaction product had a titrimetrically determined free isocyanate group content of 1.54% by weight.

The urea thickener was prepared as follows:

A vacuum mixer was charged with 3000 g of diisodecyl phthalate (DIDP, Palatinol® Z, BASF) and 480 g of 4,4′-methylenediphenyl diisocyanate (MDI; Desmodur® 44 MC L, Bayer) and this initial charge was slightly heated. Then 270 g of monobutylamine were added slowly dropwise with vigorous stirring. The resultant paste was stirred for 1 hour more under vacuum and with cooling.

To prepare the first components (A) of each of Examples 1 to 7, 1000 g of this paste were subsequently admixed with the amount of polyaldimine 1 listed in Table 1 for the respective example (corresponding in each case to the stated NH₂NCO ratio) and this polyaldimine was mixed in homogeneously under vacuum.

TABLE 1
Amount of polyaldimine 1 and NH₂/NCO ratio in the first
components (A) of Examples 1 to 7.

| | g polyaldimine 1/ | |
|---|---|---|
| | 1000 g paste | NH₂/NCO ratio |
| Example 1 (A) | 13.9 | 0.3 |
| Example 2 (A) | 18.5 | 0.4 |
| Example 3 (A) | 23.1 | 0.5 |
| Example 4 (A) | 27.8 | 0.6 |
| Example 5 (A) | 32.4 | 0.7 |
| Example 6 (A) | 37.0 | 0.8 |
| Example 7 (A) | 41.7 | 0.9 |

The resultant first components (A) of Examples 1 to 7 were dispensed immediately following their preparation into aluminum cartridges having a diameter of 45 mm, which were given an airtight seal and stored in an oven at 60° C.

### b) Testing of the First Component (A):

After one day the first components (A) were tested for expression force, skinning time and volume-curing rate; after 7 days the expression force of the first components (A) was measured again.

The expression force (EPF) of the first components (A) was determined in each case on a freshly opened cartridge at room temperature, the polyurethane composition being pressed through a 5 mm aperture at the tip of the cartridge at 23° C. without the addition of a water-containing component. Expression was carried out by means of a tensile testing machine at a constant speed of 60 mm/min. The change in the expression force is a measure of the storage stability of the polyurethane composition.

The skinning time was determined by applying the first components (A), which were at room temperature, in a layer thickness of 3 mm to cardboard at 23° C. and 50% relative humidity, without adding a water-containing component, and then determining the time which elapsed until the applied layer no longer left any residues on an LDPE pipette when the pipette was touched gently against its surface.

The curing rate of the first components (A) was determined at 23° C. and 50% relative atmospheric humidity on a PTFE substrate.

The results of the tests performed are set out in Table 2.

TABLE 2
Expression force, skinning time and curing rate of the first components
(A) of Examples 1 to 7.

| | | | Skinning | |
|---|---|---|---|---|
| | EPF fresh¹ | EPF stored² | time | Curing rate |
| | (N) | (N) | (min) | (mm/day) |
| (Ref.)³ | 621 | 820 | 180 | 3.0 |
| Example 1 (A) | 612 | 801 | 60 | 3.2 |
| Example 2 (A) | 595 | 788 | 50 | 3.3 |
| Example 3 (A) | 586 | 786 | 42 | 3.5 |
| Example 4 (A) | 586 | 774 | 35 | 3.4 |
| Example 5 (A) | 572 | 757 | 31 | 3.4 |
| Example 6 (A) | 550 | 734 | 28 | 3.2 |
| Example 7 (A) | 534 | 731 | 26 | 3.2 |

¹Expression force after one day of storage at 60° C.
²Expression force after 7 days of storage at 60° C.
³(Ref.) = reference value: same first component (A) as for Example 1 to 7 but without incorporation of polyaldimine 1 and benzoic acid.

The results in Table 2 show that the first components (A) of Examples 1 to 7 in the absence of moisture possess an outstanding storage stability (as good as or better than the non-polyaldimine-containing reference adhesive) and cure even without the addition of a water-containing second component (B).

### c) Preparation of the Two-Component Polyurethane Compositions of the Invention:

After one day of storage in an oven at 60° C. the first components (A) were heated to 80° C. and were applied with admixing of the second component (B), which is at room temperature.

The two components (A) and (B) were mixed continuously in the course of application by means of a metering attachment of the Sika® Booster type (available from Sika Schweiz AG), where the substance present in the integrated container had been replaced by the second component (B). The Sika® Booster thus modified was mounted on a cartridge comprising the first component (A) of the respective example and was operated passively by the pressure exerted on the cartridge by means of a commercially customary cartridge press. A static mixer having a diameter of 16 mm and 6 mixing elements, corresponding to a mixing path of 70 mm, was screwed onto the exit aperture of the modified Sika® Booster. This mixing apparatus meant that the mixing of the two components (A) and (B) of the two-component polyurethane composition was essentially layerlike. The amount of the second component (B) added was 2% by weight, based on the first component (A).

### d) Testing of the Two-Component Polyurethane Compositions of the Invention as Adhesives:

Immediately after their preparation, the two-component polyurethane compositions of the invention were tested for open time, early strength and bubble formation, for mechanical properties after curing, and for adhesion properties.

In order to determine the open time, i.e. the maximum possible time in which the adhesive following its application can still be worked—by brushing, for instance, or by press application to an article or to a solids surface to be bonded, the adhesive was applied in the form of a triangular bead with a cross section of about 1 cm to an LDPE sheet and then the bead was pretreated at regular intervals of time with a glass platelet which prior to use had been pretreated with Sika® Aktivator (available from Sika Schweiz AG) and flashed off for 10 minutes, the glass plate was immediately pressed in to an adhesive thickness of about 5 mm and inscribed with the time which elapsed between application of the bead and pressing-in of the platelet. After curing had been carried out at 23° C. and 50% relative atmospheric humidity for one day, the adhesion between adhesive and glass was determined by removing the adhesive layer, as described later on below. The last of the glass platelets which still showed a completely cohesive adhesion pattern then indicated the open time.

The early strength was determined as follows. First two glass platelets measuring 40×100×6 mm were pretreated on the side intended for adhesion with Sika® Aktivator (available from Sika Schweiz AG). After a flash-off time of 10 minutes the adhesive was applied as a triangular bead along the long edge of one of the glass platelets. After about one minute the applied adhesive was pressed to a thickness of 5 mm (corresponding to a bond width of about 1 cm) using the second glass platelet, by means of a tensile machine (Zwick), and then stored at 23° C. and 50% relative atmospheric humidity. After 60, 120 and 240 minutes respectively three of the bonded glass platelets per batch were pulled apart at a tensile speed of 200 mm/min, the maximum force required for this was recorded in N/cm bead length and the result was averaged over the three samples.

Formation of bubbles was determined as follows. The adhesive was applied as a triangular bead with a diameter of about 1 cm to a glass platelet which prior to use had been pretreated with Sika® Aktivator (available from Sika Schweiz AG) and flashed off for 10 minutes, the triangular bead the bead was covered with an LDPE strip and the strip was pressed in to an adhesive thickness of 5 mm. After the adhesive had cured at 23° C. and 50% relative atmospheric humidity for one day the adhesive was cut open and a qualitative assessment was made on the basis of the amount of bubbles visible to the eye, both in the adhesive and in the adhesion face between glass and adhesive.

The results of the tests performed are set out in Table 3.

TABLE 3
Open time, early strength and bubble formation of the two-component
polyurethane compositions of the invention from examples 1 to 7.

| | | Early strength (N/cm) | | | |
|---|---|---|---|---|---|
| | Open time | after | after | after | Bubble |
| | (min) | 60 min | 120 min | 240 min | formation |
| (Ref.)⁴ | >30 | 1.8 | 2.2 | 7.1 | none |
| Example 1 | 28 | 3.6 | 5.8 | 14.8 | none |
| Example 2 | 24 | 7.3 | 13.6 | 25.7 | none |
| Example 3 | 22 | 10.7 | 32.4 | 70.9 | none |
| Example 4 | 22 | 23.0 | 70.2 | 152.0 | none |
| Example 5 | 20 | 30.9 | 83.6 | 166.0 | none |
| Example 6 | 20 | 30.5 | 85.3 | 169.3 | none |
| Example 7 | 18 | 30.2 | 85.8 | 169.7 | none |

⁴(Ref.) = reference value: same adhesive as for examples 1 to 7 but first component (A) without polyaldimine 1 or benzoic acid.

The results in Table 3 show that the two-component polyurethane compositions of the invention from examples 1 to 7, in contrast to the non-polyaldimine-containing reference adhesive, possess good to outstanding early strength values after from one to 4 hours following their application. This is particularly pronounced for examples 3 to 7, particularly 4 to 7 (NH₂/NCO ratio 0.6 to 0.9), which after 4 hours had early strength values which come close to the values for the strength after full curing. The rapid development of strength is not to the detriment of the open time, which for all of the examples is long enough for practical processing. Similarly, despite the very rapid curing reaction, no disruptive gas bubbles are formed, such as is otherwise often the case in rapid moisture-curing polyurethane compositions, where it frequently leads to detractions in the mechanical properties and in the adhesion.

The mechanical properties of the adhesives were determined by applying the adhesive in the form of a film with a thickness of approximately 2 mm to a PTFE substrate, curing the film at 23° C. and 50% relative atmospheric humidity for 7 days and then testing it in accordance with DIN EN 53504 for tensile strength, breaking elongation and elasticity modulus at 0.5 to 5% elongation (tensile speed: 200 mm/min).

The results of the tests performed are set out in Table 4.

TABLE 4
Mechanical properties of the two-component polyurethane compositions
of the invention from examples 1 to 7.

| | Tensile | Elasticity | Tensile shear | Breaking |
|---|---|---|---|---|
| | strength | modulus | strength | elongation |
| | (MPa) | (MPa) | (MPa) | (%) |
| (Ref.)⁵ | 4.6 | 3.7 | 2.2 | 220 |
| Example 1 | 4.5 | 3.4 | 2.7 | 250 |
| Example 2 | 4.3 | 3.4 | 3.0 | 230 |
| Example 3 | 4.6 | 3.6 | 3.1 | 250 |
| Example 4 | 4.5 | 3.3 | 3.2 | 250 |
| Example 5 | 4.5 | 3.3 | 3.0 | 250 |
| Example 6 | 4.5 | 3.3 | 3.5 | 280 |
| Example 7 | 4.5 | 3.4 | 3.6 | 260 |

⁵(Ref.) = reference value: same adhesive as for examples 1 to 7 but first component (A) without polyaldimine 1 or benzoic acid.

The results in Table 4 show that the two-component polyurethane compositions of the invention from examples 1 to 7, after full curing, possess very good values for the mechanical properties. The values for all of the examples, irrespective of the NH₂/NCO ratio chosen, differ only slightly from those for the non-polyaldimine-containing reference adhesive; in particular there is no unwanted increase in the values for the elasticity modulus.

For the adhesion tests the respective solids surface was precleaned with isopropanol (acrylate topcoat, Autocryl Plus white, Akzo Nobel) or abraded with abrasive wool (plain aluminum, AlMgSil, Rocholl, Schönbrunn, Germany; hot-dip-galvanized steel, plain, hot-dip-galvanized ST 02 Z 275-NA, Rocholl), pretreated with Sika® Aktivator (available from Sika Schweiz AG) and then after a 10-minute flash-off time the adhesive was applied as a triangular bead with a diameter of about 1 cm, the bead was overlaid with an LDPE strip and the strip was pressed on gently. After 7 days of storage at 23° C. and 50% relative atmospheric humidity (indicated as “RT” in Table 5) and a further 7 days at 70° C. and 100% relative atmospheric humidity (indicated as “CC” (condensation conditions) in Table 5) the adhesion was tested by means of the “bead test”. In this test an incision is made at the end just above the adhesion face. The incised end of the bead is held with round-end tweezers and pulled from the surface. This is done by carefully rolling up the bead on the tip of the tweezers, and placing a cut vertical to the bead-drawing direction down to the bare surface. The rate of removal of the bead is to be chosen such that a cut has to be made about every 3 seconds (cut spacing about 2 to 3 mm). The test length must amount to at least 8 cm. The adhesion properties are evaluated on the basis of the adhesive which remains after the bead has been removed from the surface (cohesive fracture), specifically by estimating the cohesive proportion of the adhesion face in accordance with the following scale:

1=more than 95% cohesive fracture

2=75-95% cohesive fracture

3=25-75% cohesive fracture

4=less than 25% cohesive fracture

5=adhesive fracture

Test results with cohesive fracture values of less than 75% are considered to be inadequate.

The results of the tests performed are set out in Table 5.

TABLE 5
Adhesion of the two-component polyurethane compositions of the
invention from examples 1 to 7 on different solids surfaces

| | | |
|---|---|---|
| Acrylic topcoat | Aluminum | Steel |

| | RT | CC | RT | CC | RT | CC |
|---|---|---|---|---|---|---|
| (Ref.)⁶ | 1 | 1 | 1 | 1 | 1 | 1 |
| Example 1 | 1 | 1 | 1 | 1 | 1 | 1 |
| Example 3 | 1 | 1 | 1 | 1 | 1 | 1 |
| Example 5 | 2 | 1 | 1 | 1 | 1 | 1 |

⁶(Ref.) = reference value: same adhesive as for examples 1 to 7 but first component (A) without polyaldimine 1 or benzoic acid.

The results in Table 4 show that the two-component polyurethane compositions of the invention from examples 1 to 7 exhibit outstanding adhesion on different substrates. Despite the very rapid development of strength, which in the case of conventional moisture-curing polyurethane compositions is known to lead often to adhesion detractions, they are therefore no different in their adhesion behavior from the reference adhesive formulated without polyaldimine.

### Comparative Example 8

### Comp. 8

As described for examples 1 to 7, 1250 g of prepolymer 1, 500 g of prepolymer 2, 1750 g of kaolin, 1240 g of urea thickener, 25 g of 3-glycidyloxypropyltrimethoxysilane (Silquest® A-187, OSI Crompton) and 50 g of catalyst solution 1 were processed to a homogeneous paste.

Prepolymers 1 and 2 and the urea thickener were prepared as described in examples 1 to 7.

Catalyst solution 1 was prepared as follows:

10 g of 2,2′-dimorpholinodiethyl ether (DMDEE) and 1 g of dibutyltin dilaurate (DBTDL; Metatin® catalyst 712, Acima/Rohm & Haas; tin content 18.5% by weight) were combined with 89 g of diisodecyl phthalate (DIDP; Palatinol® Z, BASF) and mixed to form a homogeneous solution.

The resulting first component (A) was dispensed immediately following its preparation into aluminum cartridges having a diameter of 45 mm, which were given an airtight seal and stored in an oven at 60° C. After one day the first component (A) was tested for expression force, as described in examples 1 to 7. After 7 days the expression force was measured again.

After one day of storage in an oven at 60° C. the first component (A) was heated to 80° C. and with addition of the second component (B), which is at room temperature, was applied as described for examples 1 to 7. The adhesive obtained as a result was tested for early strength and bubble formation, as described for examples 1 to 7.

The results of the tests performed are set out in Table 6.

TABLE 6
Properties of the first component (A) and of the two-component
polyurethane composition of comparative example comp. 8.

| | EPF fresh⁷ | EPF stored⁸ | Early strength | |
|---|---|---|---|---|
| | comp. (A) | comp. (A) | after 240 min. | Bubbles |
| | (N) | (N) | (N/cm) | formed |
| Comp. 8 | 603 | 860 | 35.3 | very many⁹ |

⁷Expression force after one day of storage at 60° C. ⁸Expression force after 7 days of storage at 60° C. ⁹Bubbles are present in particular in the adhesion face between glass and adhesive (leads to adhesive fracture under load).

The results in Table 6 show that the two-component polyurethane composition of comparative example 8, which is accelerated by conventional NCO catalysis by means of an amine/tin catalyst, tends greatly to form bubbles on application. As a result the mechanical properties after curing and in particular the adhesion properties (adhesion force) of the adhesive are massively adversely affected, which can lead to a functional failure of an adhesive bond.

### Comparative Examples 9 to 12

### Comp. 9 to Comp. 12

As described for examples 1 to 7, 1250 g of prepolymer 1, 500 g of prepolymer 2, 1750 g of kaolin, 1240 g of urea thickener, 25 g of 3-glycidyloxypropyltrimethoxysilane (Silquest® A-187, OSI Crompton) and 10 g of benzoic acid were processed to a homogeneous paste.

Prepolymers 1 and 2 and the urea thickener were prepared as described in examples 1 to 7.

For each of comparative examples comp. 9 to comp. 12, subsequently, 1000 g of this paste were admixed with the amount of a blocked curing agent set out in Table 7 for the respective example (in an NH₂/NCO ratio of 0.70 for all of the examples) and this curing agent was mixed in homogeneously under vacuum and in the absence of moisture.

The resulting first components (A) were dispensed immediately following their preparation into aluminum cartridges having a diameter of 45 mm, which were given an airtight seal and stored in an oven at 60° C. After one day the first components (A) were tested for expression force, as described in examples 1 to 7. After 7 days the expression force was measured again.

After one day of storage in an oven at 60° C. the first components (A) were heated to 80° C. and with addition of the second component (B), which is at room temperature, were applied as described for examples 1 to 7. The adhesive obtained as a result was tested for bubble formation, as described for examples 1 to 7.

The results of the tests performed are set out in Table 7.

TABLE 7
Type and amount of blocked curing agent in the first component (A),
expression force and bubble formation of the two-component
polyurethane compositions of comparative examples
comp. 9 to comp. 12.

| | | | | EPF | |
|---|---|---|---|---|---|
| | | g curing | EPF | comp. | |
| | | agent/ | comp. (A) | (A) | |
| | Blocked curing | 1000 g | fresh¹⁰ | stored¹⁰ | Bubbles |
| | agent in comp. (A) | paste | (N) | (N) | formed |
| Comp. 9 | polyaldimine 2 | 20.3 | 1290 | >2500 | none |
| Comp. 10 | polyketimine¹² | 19.3 | 1750 | >2500 | none |
| Comp. 11 | polyoxazolidine¹³ | 27.9 | 1330 | >2500 | none |
| Comp. 12 | ethylenediamine/ | 69.0 | 580 | 780 | many |
| | molecular sieve¹⁴ | | | | |

¹⁰Expression force after one day of storage at 60° C.
¹¹Expression force after 7 days of storage at 60° C.
¹²Isophoronedi(methyl isobutyl ketimine), CAS 66230-21-5 (Desmophen ® LS 2965, Bayer).
¹³Härter OZ (Bayer).
¹⁴Prepared by suspending 10 g of ethylenediamine and 90 g of activated molecular sieve (4 Å) in 100 g of diisodecyl phthalate (DIDP; Palatinol ® Z, BASF) and stirring at 23° C. for 2 days.

The results in Table 7 show that the two-component polyurethane compositions of comparative examples comp. 9 to comp. 12 all have weaknesses as compared with the two-component polyurethane compositions of the invention from examples 1 to 7. Although the two-component polyurethane compositions of comparative examples comp. 9 to comp. 11 do cure without bubbles, their first components (A) are all not stable on storage, since they include, as blocked curing agents, substances which even in the absence of water react with aromatic isocyanates. The polyaldimine 2 used in comparative example comp. 9 is synthesized from an aldehyde which has a C—H group positioned α to the formyl group. In comparative examples comp. 10 and comp. 11 there are two blocked curing agents known from their use in PU coating materials; in comparative example comp. 10 there is a polyketimine, and in comparative example comp. 11 a polyoxazolidine. In comparative example comp. 12, in turn, the first component (A), comprising as blocked curing agent a diamine bound to molecular sieve, is indeed stable on storage; however, the adhesive obtained after the second component (B) has been mixed in shows a tendency to form bubbles, which adversely affect its mechanical properties after curing and may result in weaknesses in the adhesion behavior.

### Example 13

This example demonstrates the preparation of a two-component polyurethane composition of the invention and its use as an adhesive.

In a vacuum mixer 1000 g of prepolymer 1, 1250 g of prepolymer 3, 1250 g of carbon black, 600 g of kaolin, 250 g of diisodecyl phthalate (DIDP; Palatinol® Z, BASF), 300 g of urea thickener, 25 g of 3-glycidyloxypropyl-trimethoxysilane (Silquest® A-187, OSi Crompton), 325 g of polyaldimine 3 (i.e., NH₂/NCO=0.66) and 5 g of benzoic acid were processed in the absence of moisture to form a lump-free, homogeneous paste.

Prepolymer 1 and the urea thickener were prepared as described in Example 1.

Prepolymer 3 was prepared as follows:

1770 g of polyol Acclaim® 4200 N (Bayer) and 230 g of 4,4′-methylenediphenyl diisocyanate (MDI; Desmodur® 44 MC L, Bayer) were reacted by a known method at 80° C. to form an NCO-terminated polyurethane prepolymer. The reaction product had a titrimetrically determined free isocyanate group content of 1.97% by weight.

The resulting first component (A) was dispensed immediately following its preparation into aluminum cartridges having a diameter of 45 mm, which were given an airtight seal and stored in an oven at 60° C. After one day the first component (A) was tested for expression force, as described in examples 1 to 7. After 7 days the expression force was measured again.

After one day of storage in an oven at 60° C. the first component (A) was heated to 80° C. and with addition of the second component (B), which is at room temperature, was applied as described for examples 1 to 7. The adhesive obtained as a result was tested for bubble formation and also for its mechanical properties after curing, as described for examples 1 to 7.

The results of the tests performed are set out in Table 8.

TABLE 8
Expression force of the first component (A), bubble formation and
mechanical properties of the two-component polyurethane composition
of the invention from example 13.

| | EPF | EPF | | | | |
|---|---|---|---|---|---|---|
| | comp. | comp. | | | | |
| | (A) | (A) | | Tensile | Elasticity | Breaking |
| | fresh¹⁵ | stored¹⁶ | Bubbles | strength | modulus | elongation |
| | (N) | (N) | formed | (MPa) | (MPa) | (%) |
| (Ref.)¹⁷ | 1220 | 1740 | many | 8.1 | 7.3 | 360 |
| Example | 1115 | 1580 | none | 7.9 | 6.8 | 500 |
| 13 | | | | | | |

¹⁵Expression force after one day of storage at 60° C.
¹⁶Expression force after 7 days of storage at 60° C.
¹⁷(Ref.) = reference value: same adhesive as for example 13 but first component (A) without polyaldimine 1 or benzoic acid, instead with additionally 150 g of diisodecyl phthalate (DIDP; Palatinol ® Z, BASF) and with 50 g of catalyst solution 1 from example 8.

The results in Table 8 show that the first component (A) of the two-component polyurethane composition of the invention from example 13 possesses a similarly good storage stability as the polyaldimine-free first component (A) of the reference adhesive, accelerated by conventional NCO catalysis by means of an amine/tin catalyst. In contrast to the reference adhesive, which is susceptible to bubbles, the adhesive of the invention cures completely without bubbles. After full curing it possesses very good values for the mechanical properties. The values differ only slightly from those for the reference adhesive; in particular there is no unwanted increase in the values for the elasticity modulus. At no time does the adhesive of example 13 exhibit a disruptive odor.

### Examples 14 and 15

These examples demonstrate the preparation of two-component polyurethane compositions of the invention and their use as adhesives.

As described for example 13, 1000 g of prepolymer 1, 1250 g of prepolymer 3, 1250 g of carbon black, 600 g of kaolin, 250 g of diisodecyl phthalate (DIDP; Palatinol® Z, BASF), 300 g of urea thickener and 25 g of 3-glycidyloxypropyltrimethoxysilane (Silquest® A-187, OSi Crompton) were processed in the absence of moisture to form a lump-free, homogeneous paste.

Prepolymer 1 and the urea thickener were prepared as described in Example 1, prepolymer 3 as described in example 13.

For preparing the first components (A) of each of examples 14 and 15, subsequently 1000 g of this paste were admixed with the type and amount of acid catalyst and polyaldimine set out in Table 9 for the respective example (corresponding in each case to the stated NH₂/NCO ratio) and these components were mixed in homogeneously under vacuum.

TABLE 9
Type and amount of acid catalyst and polyaldimine, and NH₂/NCO
ratio in the first components (A) of examples 14 and 15.

| | Acid catalyst, | Polyaldimine, | |
|---|---|---|---|
| | g/1000 g | g/1000 g | NH₂/NCO |
| | paste | paste | ratio |
| Example 14 (A) | salicyclic acid, 5 | polyaldimine 4, 32.4 | 0.66 |
| Example 15 (A) | benzoic acid, 5 | polyaldimine 5, 19.2 | 0.66 |

The first components (A) obtained in this way were dispensed immediately following their preparation into aluminum cartridges having a diameter of 45 mm, which were given an airtight seal and stored in an oven at 60° C. After one day the first components (A) were tested for expression force, as described in examples 1 to 7. After 7 days the expression force was measured again.

After one day of storage in an oven at 60° C. the first components (A) were heated to 80° C. and with addition of the second component (B), which was at room temperature, were applied as described for examples 1 to 7. The adhesives of the invention obtained in this way were tested for bubble formation and for their mechanical properties after curing, as described for examples 1 to 7.

The results of the tests performed are set out in Table 10.

TABLE 10
Expression force of the first components (A), bubble formation and
mechanical properties of the two-component polyurethane
compositions of the invention from examples 14 and 15

| | EPF | EPF | | | | |
|---|---|---|---|---|---|---|
| | comp. | comp. | | | | |
| | (A) | (A) | | Tensile | Elasticity | Breaking |
| | fresh¹⁸ | stored¹⁹ | Bubbles | strength | modulus | elongation |
| | (N) | (N) | formed | (MPa) | (MPa) | (%) |
| Example | 1140 | 1600 | none | 7.7 | 6.2 | 620 |
| 14 | | | | | | |
| Example | 1180 | 1620 | none | 8.9 | 8.0 | 490 |
| 15 | | | | | | |

¹⁸Expression force after one day of storage at 60° C.
¹⁹Expression force after 7 days of storage at 60° C.

The results in Table 10 show that the first components (A) of examples 14 and 15 possess good storage stability. The two-component polyurethane compositions of the invention from examples 14 and 15 cure entirely without bubbles and after full curing possess very good values for the mechanical properties.

What is claimed is:

1. A two-component polyurethane composition in which the first component (A) comprises
at least one polyurethane prepolymer containing isocyanate end groups, which is prepared from at least one aromatic polyisocyanate and at least one polyol,
and
at least one polyaldimine which is obtainable from at least one polyamine containing aliphatic primary amino groups and at least one aldehyde which does not contain a C—H moiety positioned α to the carbonyl group;
and the second component (B) comprises water bound to a carrier material.

2. A two-component polyurethane composition as claimed in claim 1, characterized in that the aldehyde has the formula 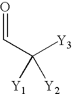
where
Y₁, Y₂ and Y₃ independently of one another are optionally substituted alkyl or aralkyl groups,
or
Y₁ is an oxy group O—Y₄, Y₄ being an optionally substituted alkyl or arylalkyl or aryl group,
and
Y₂ and Y₃ independently of one another are alkyl or arylalkyl groups each of which may optionally be substituted,
or
Y₁ and Y₂ are joined to one another to form a carbocyclic or heterocyclic ring which has a ring size of between 5 and 8, preferably 6, atoms and optionally has one or two singly unsaturated bonds,
and
Y₃ is an optionally substituted alkyl or arylalkyl group.

3. A two-component polyurethane composition as claimed in claim 1, characterized in that the aldehyde has the formula 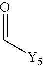
where Y₅ is an optionally substituted aryl or heteroaryl group which has a ring size of between 5 and 8, preferably 6, atoms.

4. A two-component polyurethane composition as claimed in claim 1, characterized in that the aldehyde has the formula 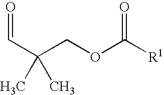
where R¹
alternatively is
a linear or branched alkyl chain, optionally containing at least one heteroatom, in particular containing at least one ether oxygen, or is a mono- or polyunsaturated linear or branched hydrocarbon chain;
or is 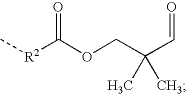
or is 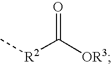
where R² is a linear or branched or cyclic alkylene chain, optionally containing at least one heteroatom, in particular containing at least one ether oxygen, or is a mono- or polyunsaturated linear or branched or cyclic hydrocarbon chain,
and
R³ is a linear or branched alkyl chain.

5. A two-component polyurethane composition as claimed in claim 4, characterized in that the aldehyde has the formula 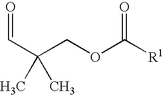
where R¹
alternatively is
a linear or branched alkyl chain having 11 to 30 carbon atoms, optionally containing at least one heteroatom, in particular containing at least one ether oxygen, or is a mono- or polyunsaturated linear or branched hydrocarbon chain having 11 to 30 carbon atoms;
or is 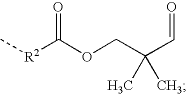
or is 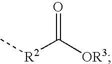
where R² is a linear or branched or cyclic alkylene chain having 2 to 16 carbon atoms, optionally containing at least one heteroatom, in particular containing at least one ether oxygen, or is a mono- or polyunsaturated linear or branched or cyclic hydrocarbon chain having 2 to 16 carbon atoms,
and
R³ is a linear or branched alkyl chain having 1 to 8 carbon atoms.

6. A two-component polyurethane composition as claimed in claim 4, characterized in that the aldehyde used for preparing the polyaldimine is obtainable by an esterification reaction of 3-hydroxypivalaldehyde with a carboxylic acid, in particular without using a solvent, 3-hydroxypivalaldehyde being prepared if desired in situ from formaldehyde, or paraformaldehyde, and isobutyraldehyde.

7. A two-component polyurethane composition as claimed in claim 6, characterized in that the carboxylic acid used for preparing the aldehyde is selected from the group consisting of lauric acid, myristic acid, palmitic acid, stearic acid, oleic acid, linoleic acid, linolenic acid, succinic acid, adipic acid, azelaic acid and sebacic acid.

8. A two-component polyurethane composition as claimed in claim 1, characterized in that the polyamine containing aliphatic primary amino groups is selected from the group consisting of 1,6-hexamethylenediamine, MPMD, DAMP, IPDA, 4-aminomethyl-1,8-octanediamine, 1,3-xylylenediamine, 1,3-bis(aminomethyl)cyclohexane, bis(4-aminocyclohexyl)methane, bis(4-amino-3-methylcyclohexyl)methane, 3(4),8(9)-bis(aminomethyl)tricyclo[5.2.1.0²,6]decane, 1,4-diamino-2,2,6-trimethylcyclohexane, polyoxyalkylene-polyamines having theoretically two or three amino groups, especially Jeffamine® EDR-148, Jeffamine® D-230, Jeffamine® D-400 and Jeffamine® T-403, and also mixtures of two or more of the aforementioned polyamines.

9. A two-component polyurethane composition as claimed in claim 1, characterized in that for preparing the polyaldimine the aldehyde is used stoichiometrically or in a stoichiometric excess in relation to the primary amino groups of the polyamine.

10. A two-component polyurethane composition as claimed in claim 1, characterized in that the polyol for preparing the polyurethane prepolymer has an average OH functionality of from 1.6 to 3.

11. A two-component polyurethane composition as claimed in claim 10, characterized in that the polyol is a polyoxyalkylene polyol, in particular a polyoxyalkylene diol or polyoxyalkylene triol, in particular a polyoxypropylene diol or polyoxypropylene triol or an EO-endcapped polyoxypropylene diol or triol.

12. A two-component polyurethane composition as claimed in claim 10, characterized in that the polyol is a polyoxyalkylene polyol having a degree of unsaturation <0.02 meq/g and a molecular weight Mₙ of from 1000 to 30 000 g/mol.

13. A two-component polyurethane composition as claimed in claim 12, characterized in that the polyol is a polyol prepared by means of DMC catalysis.

14. A two-component polyurethane composition as claimed in claim 1, characterized in that the polyurethane prepolymer and the polyaldimine are in a ratio of from 0.1 to 1.1, in particular from 0.5 to 1.1, preferably in a ratio of from 0.6 to 0.9 equivalent of aldimine groups per equivalent of isocyanate groups.

15. A two-component polyurethane composition as claimed in claim 1, characterized in that the carrier material of the second component (B) is a polymer containing ionic groups.

16. A method of mixing a two-component polyurethane composition as claimed in claim 1, characterized in that the mixing ratio of the first component (A) to the second component (B) is chosen such that the ratio of equivalent of water to equivalent of aldimine groups is from 0.5 to 10.0, in particular from 1.0 to 5.0.

17. A method of mixing as claimed in claim 16, characterized in that the two components are mixed essentially homogeneously.

18. A method of mixing as claimed in claim 16, characterized in that the two components are mixed in an essentially layerlike manner.

19. A method of mixing as claimed in claim 16, characterized in that the mixing of the two components (A) and (B) takes place by means of a metering attachment comprising two interengaging metering rotors, and also, if desired, additionally by means of a static mixer mounted at the exit aperture of this metering attachment.

20. A process for applying a two-component polyurethane composition as claimed in claim 1, characterized in that it comprises the following steps:
mixing the two components (A) and (B)
contacting at least one solids surface with the mixed polyurethane composition
curing the mixed polyurethane composition.

21. A process for applying as claimed in claim 20, characterized in that the contacting of the solids surface takes place by applying a bead to the surface.

22. A process for applying as claimed in claim 20, characterized in that the mixing of the two components (A) and (B) takes place by means of a metering attachment comprising two interengaging metering rotors, and also, if desired, additionally by means of a static mixer mounted at the exit aperture of this metering attachment.

23. A process as claimed in claim 22, characterized in that the metering attachment is mounted on a commercially customary cartridge which comprises the first component (A), and the second component (B) is in a container integrated in the metering attachment.

24. The use of a two-component polyurethane composition as claimed in claim 1 as an adhesive, sealant or covering, in particular as an adhesive or sealant.

25. A process for preparing a two-component polyurethane composition as claimed in claim 1, characterized in that it comprises a step of preparing a polyaldimine from an aldehyde and a polyamine.
